(19) United States
(12) Patent Application Publication
(10) Pub. No.: US 2024/0093512 A1
(43) Pub. Date: Mar. 21, 2024

(54) PHOTO-CURABLE INSULATION FOAM, DISPENSER FOR INJECTION THEREOF, AND METHODS OF USING SAME IN THE INSULATION

(71) Applicant: CERTAINTEED LLC, Malvern, PA (US)

(72) Inventors: Ying Wang, Acton, MA (US); Choung-Houng Lai, Acton, MA (US); Nicholas David Orf, Natick, MA (US); Rachel Brown, Sutton, MA (US); Nicky Chan, Hudson, MA (US)

(21) Appl. No.: 18/256,168

(22) PCT Filed: Dec. 7, 2021
(86) PCT No.: PCT/US2021/062200

§ 371 Date: Jun. 6, 2023

Related U.S. Application Data
(60) Provisional application No. 63/122,381, filed on Dec. 7, 2020.

(51) Int. Cl. E04F 21/08; C08J 9/14

(52) U.S. Cl. CPC E04F 21/085; C08J 9/147; C08J 2203/142; C08J 2333/10; C08J 2363/00

(57) ABSTRACT

Provided are photo-curable foam-forming compositions, methods of making and using them, and a dispenser for injecting the foam-forming composition for the insulation of buildings. In one aspect, the present disclosure provides for a method of insulating a surface, such as that of a building cavity with an insulating foam, the method comprising: irradiating a foam-forming composition with light, the foam-forming composition comprising: a polymerizable component (e.g., based on epoxy or acrylate); an effective amount of a photoinitiator; and a blowing agent; and injecting the irradiated foam-forming composition adjacent the surface.

### CROSS-REFERENCE TO RELATED APPLICATIONS

This application claims the benefit of priority of U.S. Provisional Patent Application No. 63/122,381, filed Dec. 7, 2020, which is hereby incorporated herein by reference in its entirety.

### BACKGROUND OF THE DISCLOSURE

### 1. Field of the Disclosure

The present disclosure relates generally to insulation foam. The present disclosure relates more particularly to a photo-curable foam composition; methods of using it; a dispenser for irradiating the foam composition; and methods for using the dispenser.

### 2. Technical Background

Heating and cooling of buildings uses approximately 35% of all energy consumed in the United States per year. As a result of innovations in construction materials and practices, new buildings use less than half the energy per square foot of older buildings. However, the number of new buildings built each year is only about 2% of the number of existing buildings. Given that most buildings last for 50 years or more, it will take generations before low energy new buildings begin to have a significant impact on overall energy usage. Thus, there is a need for simple, low-cost retrofit energy saving technologies that can be applied to existing buildings to achieve energy use similar to new buildings, and also to continue to improve upon construction methodologies for new constructions.

The most common approach to reduce thermal energy use in existing buildings is weatherization, where a contractor seals air leaks and adds additional blown-in fibrous insulation to critical areas such as the attic. Federal and state governments have invested billions of dollars in weatherization programs. However, studies indicate that weatherization results in an average energy savings of only 15% and does not result in energy efficiency similar to a new construction. For example, a recent study of weatherization programs jointly conducted by MIT, the University of Chicago, and the University of California concluded that the average annual return on government funded weatherization programs is −9%. As such, current weatherization protocols fail to financially incentivize increased energy efficiency.

Another approach to reduce thermal energy use in buildings is to conduct a deep energy retrofit. As opposed to the 15% energy savings expected of typical weatherization, a deep energy retrofit of a building can reduce the thermal energy use by 30%-50%. Typical deep energy retrofits involve resetting windows, reconfiguring roof eaves, and fitting foam boards to building exteriors underneath the siding. Due to the invasive nature of this process, the cost and time involved is very high. Typical project lengths span several months and can require building occupants to temporarily vacate. Further, the typical payback period is 25 years or more. Conventional deep energy retrofits are not economically viable on a large scale.

Injection of insulation foam into cavities within a building can achieve many of the same benefits of a traditional deep energy retrofit at costs that are an order of magnitude lower, if not less. Further, foam injection projects can typically be completed in several days rather than in months. Closed cell foam in particular offers many advantages over traditional fiberglass or cellulose insulation as it has twice the insulation value per inch and serves as both an air barrier and vapor barrier. Energy models of a house injected with closed cell foam indicate that thermal energy savings of 30%-50% can be achieved. A typical house can be injected in three days and the modeled payback time is only five years, or even less if high energy savings are realized.

Spray and injection foams are often foam-in-place, wherein liquid foams are sprayed, injected, or poured in place. A common type of spray or injection foam is polyurethane foam, where a two-component mixture composed of isocyanate and polyol resin is mixed near the tip of a gun. The two most common methods of mixing are impingement mixing, in which the two liquid component streams impact each other under high pressure, and static mixing, in which the two streams are interlaced using a series of mixing elements. However, these foams have the drawback of using isocyanates, which are carcinogenic. Further, two-component formulations require complete compatibility and miscibility between each liquid component to ensure rapid and even mixing, precluding the use of formulations with certain properties, such as two components having significantly differing viscosities.

Accordingly, there is a need in the art to develop improved foam-forming compositions and methods of using them that avoid the drawbacks of isocyanate chemistry and two-component formulations.

### SUMMARY OF THE DISCLOSURE

In one aspect, the present disclosure provides for a method of insulating a surface (e.g., of a cavity such as an building cavity) with an insulating foam, the method comprising:
irradiating a foam-forming composition with light, the foam-forming composition comprising:
   a polymerizable component (e.g., based on epoxy or acrylate) (e.g., present in the range of 20 wt % to 90 wt %);
   an effective amount of a photoinitiator (e.g., present in in the range of 0.1 wt % to 4 wt %); and
   a blowing agent (e.g., in the range of 10 wt % to 40 wt %); and
injecting the irradiated foam-forming composition adjacent a surface (e.g., into a cavity such as a building cavity.

In another aspect, the present disclosure provides for an insulating foam disposed adjacent a surface (e.g., in a cavity such as a building cavity), formed through a method as otherwise described herein.

In another aspect, the present disclosure provides for a dispenser for injecting a foam-forming composition, the dispenser comprising:
one or more inlets in fluid communication with one or more sources of the foam-forming composition as otherwise described herein;
a fluid path in communication with the inlet,
an actuator configured to actuate flow of the foam-forming composition through the fluid path;
a light source irradiating the fluid path; and
an outlet in fluid communication with the fluid path,
   the device being configured to allow flow of foam-forming composition from the inlet(s), through the fluid path and out the outlet.

In another aspect, the present disclosure provides for a method of insulating a surface (e.g., of a cavity such as a building cavity), the method comprising:
providing a dispenser as otherwise described herein;
using the dispenser to irradiate a foam-forming composition and inject the foam-forming composition from the outlet adjacent the surface (e.g., into the cavity), where the foam-forming composition is as otherwise described herein.

Additional aspects of the disclosure will be evident from the disclosure herein.

### BRIEF DESCRIPTION OF THE DRAWINGS

The accompanying drawings are included to provide a further understanding of the methods and devices of the disclosure, and are incorporated in and constitute a part of this specification. The drawings illustrate one or more embodiment(s) of the disclosure, and together with the description serve to explain the principles and operation of the disclosure.

FIG. 1 is a drawing of a dispenser according to an example embodiment.

FIG. 2 is a schematic illustrating filling a building cavity according to an example embodiment.

FIG. 3 is a graph of curing time vs photoinitiator concentration according to an example embodiment.

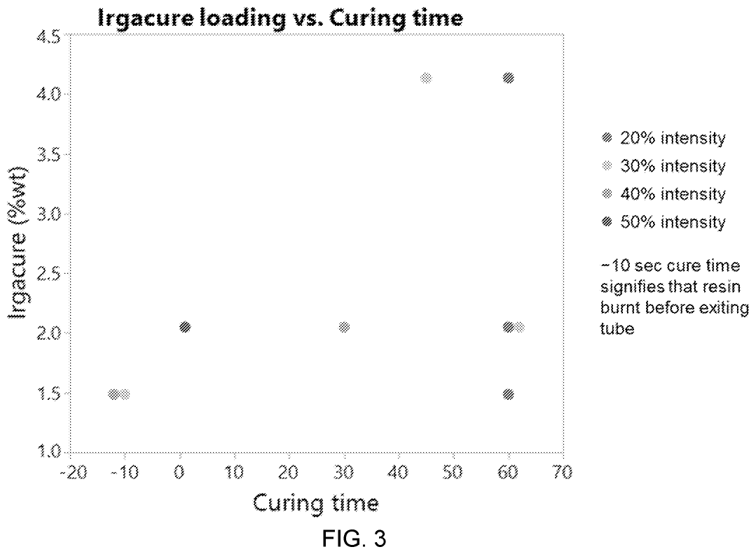

FIG. 4 displays pictures of epoxy insulating foams according to example embodiments.

### DETAILED DESCRIPTION

The present inventors have noted certain issues with the state-of-the-art two-part polyurethane foam compositions typically used in insulation of building cavities. In contrast to these polyurethane foam compositions, the present disclosure provides a photo-curable insulating foam formed by irradiation of a foam-forming composition, including a polymerizable component that is based, e.g., on epoxy or acrylate. Notably, this approach means that the foam-forming composition can be provided as a one-component system, e.g., without the need to separate reactive components of the polymerizable mixture before they are to be polymerized. This is a key advantage over conventional foams, which are typically formed through the mixing of two distinct liquids which react to form a cured foam. Such a two-component approach presents considerable design constraints in order to ensure that the two liquids have the appropriate miscibility and reaction kinetics to form a stable foam with the desired properties. Further, a two-component mixture inherently is more complicated to store and use. For example, two component formulations typically need to have reasonably matched viscosities, otherwise the mixing between phases is inefficient and often inadequate. Most spraying systems also require nearly 1:1 volume ratio for facile mixing, precluding certain formulations and sometimes leading to wasteful dilution of at least one component.

In certain embodiments, the one-component systems described herein are based on epoxy chemistry; the cationic photoinitiator used to induce polymerization and foam curing is activated by irradiation. The present inventors have developed novel compositions, methods, and devices that allow the use of one-component foam-forming epoxy-based compositions to create insulating foams for use in insulating surfaces as described herein, and especially for use in insulating building cavities. However, the present inventors contemplate that acrylate-based photopolymerizable systems can likewise be used in the methods, compositions and systems described herein.

Accordingly, in one aspect, the present disclosure provides for a method of insulating a surface (e.g., in a cavity such as a building cavity) with an insulating foam, the method comprising:
irradiating a foam-forming composition with light, the foam-forming composition comprising:
   a polymerizable component (e.g., based on epoxy or acrylate) (e.g., present in the range of 20 wt % to 90 wt %);
   an effective amount of a photoinitiator (e.g., present in in the range of 0.1 wt % to 4 wt %); and
   a blowing agent (e.g., in the range of 10 wt % to 40 wt %); and
injecting the irradiated foam-forming composition into a building cavity.

The polymerizable component (e.g., based on epoxy or acrylate) is selected to allow efficient polymerization in light of the other composition components. As used herein, the term “polymerization” and similar terms refer to any process that provides a polymeric material from lower molecular weight materials; this can be polymerization of relatively low-molecular weight monomers, or alternatively crosslinking of species that are provided in oligomeric or even polymeric form. As the person of ordinary skill in the art will appreciate, the polymerizable component can include multiple polymerizable species (e.g., each based on epoxy chemistry, or each based on (meth)acrylate chemistry).

In certain desirable embodiments, the polymerizable component is a polymerizable epoxy component. The present inventors have determined that photopolymerizable epoxy systems are especially useful in the methods and systems described herein.

In certain embodiments as otherwise described herein, the polymerizable epoxy component comprises a cycloaliphatic epoxy. For example, the polymerizable epoxy may comprise a cycloaliphatic di-epoxy. In particular embodiments, the cycloaliphatic epoxy comprises an epoxy with the structure:

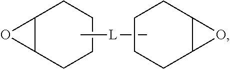

wherein
L is a bridging C₂-C₁₂ alkyl group, C₂-C₁₂ alkenyl group, or —(C₀-C₆ alkyl)-X-(C₀-C₆ alkyl)-, wherein X is —O—, —C(O)—O—, —O—C(O)—O—, —O—C(O)—N(R^{A})—, —N(R^{A})—C(O)—, —N(R^{A})—C(O)—N(R^{B})—, or —N(R^{A})—, wherein R^{A} and R^{B} are independently H, methyl, or ethyl; and
L is optionally substituted by 1-4 groups selected from C₁-C₄ alkyl, halo, oxo, and —OH.

In certain embodiments as otherwise described herein, L is a bridging C₂-C₁₀ alkyl group or —(C₀-C₆ alkyl)-X-(C₀-C₆ alkyl)-, wherein X is —O—, —C(O)—O—, —O—C(O)—O—, —O—C(O)—N(R^{A})—, —N(R^{A})—C(O)—, or —N(R^{A})— (e.g., X is —O—, —C(O)—O—, —O—C(O)—O—; or X is —C(O)—O—), wherein R^{A} and R^{B} are independently H, methyl, or ethyl; and L is optionally substituted by 1-4 groups selected from methyl, ethyl, or oxo. For example, L may be a bridging C₂-C₆ alkyl or —(C₀-C₄ alkyl)-X-(C₀-C₄ alkyl)-. In particular embodiments, L is —(C₀-C₃ alkyl)-X-(C₀-C₃ alkyl)-. For example, in certain embodiments, L is —(C₀-C₃ alkyl)-X-(C₀-C₃ alkyl)- and X is —C(O)—O.

In certain embodiments as otherwise described herein, the polymerizable epoxy component comprises bis-phenol A di-epoxy, cyclohexene oxide, 4-vinyl-1,2-cyclohexene oxide, 4-vinyl-1,2-cyclohexene dioxide, limonene dioxide, 4-epoxy-1,2-cyclohexene oxide, dicyclopentadiene diepoxide, neopentyl glycol diglydicyl ether, 1,4-butanediol diglycidyl ether, bis-(cyclohexene epoxy) derivatives (e.g., (7-oxabicyclo[4.1.0]heptan-3-yl)methyl 7-oxabicyclo[4.1.0]heptane-3-carboxylate), or benzyl glycidyl ether, or combinations thereof. In particular embodiments, the polymerizable epoxy component comprises more than one such epoxy, e.g., a blend of two epoxies, or a blend of three epoxies, or a blend of four or more epoxies. For example, in certain embodiments, the polymerizable epoxy component comprises a cycloaliphatic epoxy (e.g., (7-oxabicyclo[4.1.0]heptan-3-yl)methyl 7-oxabicyclo[4.1.0]heptane-3-carboxylate) and a bis-phenol A di-epoxy. In other embodiments, the polymerizable epoxy component comprises only one epoxy species.

As the person of ordinary skill in the art will appreciate, in typical use the epoxy cures through cationic polymerization. Cationic polymerization can be advantageous over other polymerization reactions, such as radical polymerization, because of dark cure capability, where the irradiated catalyst center (e.g., photoinitiator) remains active even after the irradiation by the light source. Further, cationic polymerization mechanisms typically have a very high reaction rate, enabling solidification of the foam and preventing the foam cells from prematurely collapsing. Accordingly, the epoxy-based materials described herein can continue to cure even after they are dispensed from a dispenser containing a light source into a building cavity.

While epoxy-based materials have been determined by the inventors to be especially suitable, the inventors also contemplate that photopolymerizable acrylate-based compositions can also be useful. As used herein, the term “acrylate-based” generally encompasses materials including acrylates, methacrylates or both. A wide variety of photopolymerizable acrylate components are suitable for use. For example, in certain desirable embodiments, the polymerizable component includes one or more acrylate- or methacrylate-terminated oligomers, e.g., with central blocks based on polyether polyols, polyurethane polyols, epoxy polyols, polyester polyols or silicones (e.g., polydimethylsiloxane). A wide variety of mono- and multifunctional (meth)acrylate monomers are also suitable for use, e.g., as reactive diluents; examples include bisphenol A di(meth)acrylate, trimethylolpropane di(meth)acrylate, ethylene glycol di(meth)acrylate, ethyl acrylate, methyl methacrylate, ethyl acrylate, ethyl methacrylate, propyl acrylate, propyl methacrylate, n-butyl acrylate, n-butyl methacrylate, n-pentyl acrylate, n-hexyl acrylate, n-hexyl methacrylate, n-heptyl acrylate, n-octyl acrylate, n-nonyl acrylate, lauryl acrylate, stearyl acrylate, stearyl methacrylate, behenyl acrylate and branched isomers thereof such as 2-ethylhexyl acrylate, cyclohexyl methacrylates, isonorbonyl acrylate and isobornyl methacrylates, glycidyl methacrylate, benzyl acrylate, benzyl methacrylate, phenyl acrylate, phenyl methacrylate, tert-butylphenyl acrylate, tert-butylphenyl methacrylate, phenoxyethyl acrylate, phenoxyethyl methacrylate, 2-butoxyethyl methacrylate, 2-butoxyethyl acrylate, dimethylaminoethyl methacrylate, dimethylaminoethyl acrylate, diethylaminoethyl methacrylate, diethylaminoethyl acrylate and tetrahydrofurfuryl acrylate, among others. A wide variety of free radical photoinitiators are well known for use in photocurable acrylate systems, e.g., benzophenone; 4,4′-bis(dimethylamino)benzophenone; halogenated benzophenones; acetophenone; α-hydroxyacetophenone; chloro acetophenones, such as dichloroacetophenones and trichloroacetophenones; dial koxyacetophenones, such as 2,2-diethoxyacetophenone; α-hydoxyalkylphenones, such as 2-hydroxy-2-methyl-1-phenyl-1-propanone and 1-hydroxycyclohexyl phenyl ketone; α-aminoalkylphenones, such as 2-methyl-4′-(methylthio)-2-morpholiniopropiophenone; benzoin; benzoin ethers, such as benzoin methyl ether, benzoin ethyl ether, and benzoin isobutyl ether; benzil ketals, such as 2,2-dimethoxy-2-phenylacetophenone; acylphosphinoxides, such as diphenyl(2,4,6-trimethylbenzoyl)phosphine oxide; xanthone derivatives; thioxanthone derivatives; fluorenone derivatives; methyl phenyl glyoxylate; acetonaphthone; anthraquninone derivatives; sulfonyl chlorides of aromatic compounds; and O-acyl α-oximinoketones, such as 1-phenyl-1,2-propanedione-2-(O-ethoxycarbonyl)oxime, among others.

The polymerizable component (e.g., polymerizable epoxy component or polymerizable acrylate-based component) may be present in the foam-forming composition in a wide range of proportions as required. In certain embodiments as otherwise described herein, the polymerizable component is present in the range of 20 wt % to 90 wt %. For example, in certain embodiments, the polymerizable epoxy is present in the foam-forming composition in the range of 30 wt % to 90 wt %, or 40 wt % to 90 wt %, or 50 wt % to 90 wt %, or 60 wt % to 90 wt %, or 20 wt % to 80 wt %, or 30 wt % to 80 wt %, or 40 wt % to 80 wt %, or 50 wt % 80 wt %, or 20 wt % to 70 wt %, or 30 wt % to 70 wt %, or 40 wt % to 70 wt %.

The foam-forming composition includes a photoinitiator in order to begin polymerization when the foam-forming composition is irradiated. In certain embodiments as otherwise described herein, the photoinitiator comprises at least one of a sulfonium salt or iodonium salt. Examples of suitable sulfonium salts include dialkylphenacylsulfonium, polyarylsulfoniums (e.g., triarylsulfonium, diphenyl(4-(phenylthio)phenyl)sulfonium, (thiobis(4,1-phenylene))bis(diphenylsulfonium) and the like) and dialkyl-4-hydroxyphenylsulfonium salts. Examples of suitable iodonium salts include diaryliodonium salts. A wide range of suitable anions may be selected to charge balance these cationic salts, based on stability and solubility. For example, anions soluble in nonpolar solvents may be used, such as fluorinated borates (e.g., tetraaryl borate, or fluorinated borate salts such as tetrakis(3,5-bis(trifluoromethyl)phenyl)borate (i.e., BArF₂₄) or tetrakis(pentafluorophenyl)borate (i.e., BArF₂₀)), hexafluorophosphate, hexafluoroantimonate, triarylhexafluoroantimonate, or arsenates (e.g., hexafluoroarsenate). In particular embodiments, the photoinitiator is a sulfonium salt. Suitable commercial photoinitiator include those sold under the tradenames Irgacure™ 270, or Irgacure™ 290 from BASF. Other suitable photoinitiators include (4-n-decyloxyphenyl)phenyl-iodonium hexafluoroantimonate, and S-methyl-S-n-dodecylphenyacylsufonium hexafluoroantimonate. In other embodiments, the photoinitiator is an iodonium salt, such as (4-isobutylphenyl)(p-tolyl)iodonium hexafluorophosphate (sold as Irgacure™ 250 from BASF).

Diazonium salts may be advantageous as they can simultaneously initiate polymerization while generating nitrogen gas, enhancing the foaming of the foam-forming composition. In certain embodiments as otherwise described herein, the photoinitiator comprises an aryl diazonium salt (e.g., benzenediazonium tetrafluoroborate).

Other suitable photoinitiators may be found in Crivello, “The Discovery and Development of Onium Salt Cationic Photoinitiators” J. Polym. Sci. Part A: Polym. Chem. 37: 4241-4253, which is hereby incorporated herein by reference in its entirety.

The photoinitiator is present in the foam-forming composition in an effective amount, i.e., effective to initiate polymerization (cationic or free radical, depending on whether the system is an epoxy system or an acrylate-based system) upon being irradiated with light of a suitable wavelength and power. In various embodiments, the photoinitiator is present in an amount in the range of 0.1 wt % to 4 wt %, e.g., 0.2 wt % to 3 wt %, or 0.5 wt % to 3 wt %, or 0.75 wt % to 3 wt %, or 1 wt % to 3 wt %. For example, in particular embodiments, the photoinitiator is present in the range of 0.2 wt % to 2.5 wt %, or 0.2 wt % to 2 wt %, or 0.5 wt % to 2 wt %, or 0.75 wt % to 2 wt %, or 1 wt % to 2 wt %. Of course, the photoinitiator component can include a single photoinitiator, or more than one photoinitiator. In certain embodiments as otherwise described herein, the foam-forming composition comprises a two, three, or four photoinitiators.

In general, photoinitiators function by absorbing light and generating a reactive species that initiates polymerization. However, photoinitiators often only efficiently absorb light at low wavelengths. This presents a challenge for efficient photocuring of a polymer, as light penetration often decreases with decreasing wavelength. Longer wavelengths achieve better penetration, but may not effectively transmit energy to the photoinitiator, as many conventional photoinitiators absorb in the ultraviolet. In order to remedy this issue, the present inventors have determined that, in certain embodiments as otherwise described herein, the foam-forming composition may advantageously further comprise a photosensitizer. Numerous photosensitizers are known in the art and may be employed. Examples of suitable photosensitizers include polycyclic compounds. For example, in certain embodiments, the photosensitizer comprises a polycyclic aromatic compound. In particular embodiments, the photosensitizer comprises anthracene or anthracene derivatives. For example, the photosensitizer may comprise one or more of anthracene, 2,4-diethyl-9H-thioxanthene-9-one, 2-ethyl-9,10-dimethoxyanthracene, 9-anthrone(9-anthranol), 9-n-butoxyanthracene, 9,10-dipropoxyanthracene, or 9,10-dibutoxyanthracene. In certain embodiments as otherwise described herein, the photosensitizer absorbs light in the range of 250 nm to 500 nm (e.g., 300 nm to 450 nm, or 300 nm to 400 nm). In certain embodiments as otherwise described herein, the photosensitizer is present in the range of 0.001 wt % to 1 wt %, or 0.01 wt % to 1 wt %, or 0.02 wt % to 1 wt %. For example, in particular embodiments, the photosensitizer is present in the range of 0.05 wt % to 1 wt %, or 0.1 wt % to 1 wt %, or 0.01 wt % to 0.8 wt %, or 0.01 wt % to 0.6 wt %, or 0.01 wt % to 0.5 wt %, or 0.05 wt % to 0.5 wt %, or 0.1 wt % to 0.5 wt %.

Advantageously, the foam-forming composition further comprises a blowing agent. Any suitable blowing agent for the provision of polymer foams may be used, including physical blowing agents and chemical blowing agents. A physical blowing agent is a compound that is provided as part of the foam-forming composition (e.g., by being emulsified or dissolved therein) that vaporizes under the conditions of the polymerization and/or dispensing to provide a foam. A chemical blowing agent is a compound provided as part of the foam-forming composition that forms one or more gaseous products via chemical reaction under the conditions of the polymerization or dispensing. In either case, a pressure drop upon dispensing of the irradiated material can help to provide gas evolution for blowing of the foam.

Chemical blowing agents can be any of a variety of chemicals that release a gas upon thermal decomposition. Chemical blowing agents are often referred to in the art as “foaming agents.” A chemical blowing agent often includes one or more decomposable groups such as azo, N-nitroso, carboxylate, carbonate, heterocyclic nitrogen-containing and sulfonyl hydrazide groups. In particular embodiments, the blowing agent is selected from endothermic and exothermic varieties, such as dinitrosopentamethylene tetraamine, p-toluene sulfonyl semicarbazide, 5-phenyltetrazole, calcium oxalate, trihydrazino-s-triazine, 5-phenyl-3,6-dihydro-1,3,4-oxandiazin-2-one, 3,6-dihydro-5,6-diphenyl-1,3,4-oxadiazin-2-one, azodicarbonamide, sodium carbonate, sodium bicarbonate, and mixtures thereof.

In certain embodiments, the blowing agent is physical blowing agent, e.g., a gas or low-boiling liquid which can provided as part of the foam-forming composition (e.g., by being dissolved therein or miscible therewith). For example, the foam-forming composition may be stored at ambient or below-ambient temperature, or at ambient or above-ambient pressure. The heat of the polymerization reaction and/or a pressure drop upon dispensing from a dispenser can help to volatilize the physical blowing agent to provide the gas that blows out the foam. In particular embodiments, the blowing agent is a fluorocarbon (e.g., a perfluorinated or partially fluorinated C₁-C₆ alkyl, such as polyfluoroethane, or polyfluoropropane (e.g., 1,1,1,3,3-pentafluoropropane), or polyfluorobutane. Certain hydrofluorocarbon blowing agents are available from Honeywell under the ENOVATE mark, e.g., HFC-245a. Hydrofluoroolefin blowing agents are available from Honeywell under the SOLSTICE mark and from Chemours under the OPTEON mark. Additional examples of suitable blowing agents include carbon dioxide, butane, pentane, and fluorinated and/or chlorinated derivatives of ethane, propane, butane, and pentane. In certain embodiments as otherwise described herein, the blowing agent is present in the foam-forming composition in an amount in the range of 5 wt % to 50 wt %, or 10 wt % to 40 wt %, or 10 wt % to 30 wt %, or 15 wt % to 40 wt %, or 15 wt % to 30 wt %.

The foam-forming composition may further include a solvent, e.g., in order to solubilize the other components and to adjust viscosity. Any solvent suitable, e.g., for rendering the other components of the foam-forming composition compatible with one another can be used. In certain embodiments as otherwise described herein, the solvent comprises a polyol or a polyether. In particular embodiments, the solvent comprises a propylene glycol derivative. For example, the solvent may be dipropylene glycol dimethyl ether. The solvent may be present in a wide range of values depending on the relative solubilities and miscibilities of other components. Further, the solvent may be adjusted to achieve particular desired foam-forming composition properties, such as appropriate viscosity for flowing through the dispenser. Solvents can also influence kinetics of foaming and final foam polymer structure. For example, alcoholic solvents can function as chain transfer agents in a cationic polymerization. The person of ordinary skill in the art can select an appropriate solvent, e.g., to manage material compatibility and to control final polymer structure. In certain embodiments as otherwise described herein, the solvent is present in an amount less than 50 wt %, for example in the range of 2 wt % to 30 wt %, or 2 wt % to 25 wt %, or 2 wt % to 20 wt %, or 2 wt % to 15 wt %, or 5 wt % to 20 wt %. In still further embodiments, the foam-forming composition does not include any solvent, rather relying on the intrinsic solubilizing ability of other components.

In certain embodiments, the foam-forming composition may further comprise a flame retardant in order to produce a more flame retardant foam. The flame retardant may be comprised of one or more components. For example, the flame retardant may comprise one or more of an organohalogen (e.g., organobromine) flame retardant, and a organophosphorous-based flame retardant. For example, the flame retardant may include tris(dichloropropyl)phosphate, tris(chloroethyl)phosphate, melamine polyphosphate, dibromo-neopentyl glycol, glycol esters or ether derived from tetrabromo or tetrachlorophthalic anhydride, tetrabromophthalate diol, as well as other reactive or non-reactive additives types of flame-retardants containing combinations of phosphorus, chlorine, bromine, and nitrogen. Particular examples of suitable flame retardants include Saytex™ RB 9170 (Albemarle) and Fyroflex™ RDP (ICL Industrial Products). In certain embodiments, the flame retardant is present in an amount sufficient to provide self-extinguishing properties to the foam. In certain embodiments, the foam-forming composition comprises a flame retardant in the range of 1 wt % to 30 wt %, e.g., 2 wt % to 25 wt %, or 5 wt % to 25 wt %, or 10 wt % to 25 wt %.

The foam-forming composition may further include any number of other additives to impart or to enhance properties desired in the final insulating foam. For example, the foam-forming composition may include one or more of a surfactant, a catalyst carrier, a co-reactant, a lubricant, a substance having fungistatic and/or bacteriostatic effects, and a filler. For example, any reasonable surfactants may be envisioned. In a particular embodiment, the surfactant may be used to regulate cell size, foam density, or a combination thereof. Exemplary surfactants include silicone-based surfactants such as those commercially available from Dow Corning Corporation of Midland, Mich. USA and Siltech Corporation of Toronto, Ontario, CA. Exemplary surfactants further include Dabco®-brand surfactants commercially available from Air Products and Chemicals, Inc. of Allentown, Pa., USA and Stuktol®-brand surfactants commercially available from CellChem International, LLC of Atlanta, Ga., USA. An exemplary catalyst carrier may be, for example, phthalates such as dimethyl phthalate, polyhydroxyl compounds, or combinations thereof. In a particular embodiment, the catalyst carrier is dimethyl phthalate. In an embodiment, at least one additive may be used to regulate the reaction rate of the polymerization of the epoxy-containing resin. For example, a co-reactant may be used to regulate the ring opening of the epoxy functional group. An exemplary co-reactant includes, for example, diols, glycerin, or combinations thereof. In an embodiment, fillers may include fibers such as glass and/or natural fibers. Other potential fillers further include micron and nano-sized particulates including clays, calcium carbonate, silica, quartz, graphite, antistatic graphenes, and carbon black.

It is to be understood that a “one-component” foam-forming composition is a composition that itself does not require addition of any other material to provide a polymerization. The materials described herein can be made to be shelf stable, not polymerizing until initiated by irradiation (or by excessive heat). Thus, a one-component foam-forming composition may have two or more polymerizable species within its polymerizable component, as long as these species do not react to form a polymer until subjected to a stimulus. Such a one-component foam-forming composition may be provided without inclusion of certain important components that do not react to become part of the polymer itself, but are useful in forming a foam, such as a foaming agent.

In certain embodiments as otherwise described herein, the insulating foam formed through the present disclosure has desirable insulating properties. For example, the insulating foam may have desirable physical properties such as thermal resistance in the range of R 3/in. to R 7/in. (R=hr° F.·ft²/BTU). The density of the foam may be in the range of 0.3 lbs/ft³ to about 5.0 lbs/ft³ as measured by ASTM D1622. In certain embodiments, the foam is substantially a closed-cell foam. “Substantially closed-cell” as use herein refers to a foam wherein the cell structure of the foam is formed of individual polyhedral cells wherein at least about 50% of the cells, or at least 60%, or at least 70%, do not have open windows or panes within each individual cell. The person of ordinary skill in the art will, based on the disclosure herein, will adjust the formulation to provide a desired set of properties.

In certain embodiments as otherwise described herein, the insulating foam may have other desirable properties such as increased adhesive bonding to a substrate. For example, the foam may have increased adhesive bonding to a paper-faced gypsum board, or to at least one of wood, brick, and stone, or to conventional insulation such as insulating board (e.g., extruded polystyrene) or fiberglass insulation.

An advantage of the present compositions is a desirable gel time which allows the irradiated foam-forming composition to exit the dispenser and rapidly cure within the building cavity. Accordingly, in certain embodiments as otherwise described herein, the irradiated foam-forming composition has a gel time in the range of 2 seconds to 240 seconds, e.g., 5 seconds to 200 seconds, or 10 seconds to 180 seconds. The person of ordinary skill in the art will, based on the disclosure herein, adjust material components to provide a desired rise time and gel time based on foam properties and economic considerations for the installation speed.

The present inventors have developed methods and composition that allow for effective irradiation and injection of a foam-forming composition. The present inventors have noted difficulties related to the partial irradiation of the foam-forming composition leading to incomplete curing. The present inventors have found that the inclusion of a blowing agent can, in certain embodiments, greatly aid foam curing by providing effective mixing during irradiation. Without wishing to be bound by theory, it has been observed that certain blowing agents tend to boil (and/or come out of solution) when exposed to the lower pressure and/or higher temperature of the irradiation. This gas movement surprisingly causes effective and rapid mixing of the solution without any moving parts, leading to more efficient irradiation of the foam-forming composition. In particular embodiments as otherwise described herein, the blowing agent boils within the fluid path (e.g., boils under irradiation, or only under irradiation, within the fluid path).

Further, it is presently believed that turbulent flow of the foam-forming composition in the fluid path may be advantageous by increasing the natural mixing, allowing for a larger fraction of the photoinitiators to be irradiated near the fluid path edge. One way this can be quantified is through the Reynolds number, which described the behavior of a fluid moving through a tube. The higher the Reynolds number, the greater chance the fluid will transition from laminar flow to turbulent flow. The Reynolds number is given by the formula: Re=ρLν/η, wherein ρ is the density of the fluid, L is a characteristic dimension of the movement (e.g., diameter of a tube), ν is the speed of the liquid, and η is the viscosity of the solution. However, calculations indicate that many formulations result in a Reynolds number much less than 1, indicating that the foam-forming composition is very far from reaching turbulent flow given current design characteristics. To remedy this fact, a dispenser, described in detail below, can include one or more protuberances into the fluid path in order to provide for turbulent flow in the zone of irradiation.

Advantageously, the present disclosure allows for a one-component foam-forming composition that does not contain certain conventional ingredients of insulation foams. Of particular concern are isocyanates, which are commonly used in insulation foams, but are also carcinogenic. Accordingly, in certain embodiments as otherwise described herein, the foam-forming composition is substantially free of isocyanates. In particular other embodiments, the foam-forming composition is substantially free of polyolefins and/or butadienes. In certain embodiments, the foam-forming composition is substantially free of initiators that substantially react with the foam precursor compounds at 25° C. in the absence of light. In certain embodiments, a material that is “substantially free of” a species has less than 0.5 wt % of such species.

As otherwise described herein, the foam-forming composition may be provided with the blowing agent incorporated therein, or the method may further comprise adding the blowing agent to a foam-forming precursor composition to produce the foam-forming composition (i.e., the foam-forming composition as otherwise described herein) immediately prior to irradiation. As used herein, the foam-forming precursor composition comprises all components of the foam-forming composition with the exception of the blowing agent.

The foam-forming composition is subjected to irradiation to initiate polymerization. Accordingly, in certain embodiments as otherwise described herein, the foam-forming composition is injected into the building cavity immediately subsequent to irradiation. For example, in certain embodiments the injection occurs less than 30 seconds after, or less than 15 seconds after, or less than 10 seconds after the irradiation step. Upon entering the building cavity, in certain embodiments as otherwise described herein, the foam-forming composition is exposed to substantially no further irradiation.

The irradiation can be carried out with a variety of wavelengths, advantageously selected to balance penetration depth and absorption by one or more of the photoinitiator and photosensitizer. In certain embodiments as otherwise described herein, the irradiating is performed with light having a wavelength in the range of 200 nm to 600 nm, or 200 nm to 500 nm, or 250 nm to 450 nm, or 300 nm to 400 nm, or 320 nm to 400 nm, or 350 nm to 420 nm, or 390 nm to 410 nm. The irradiation can be performed with a broad spectrum source, an LED array, or may be performed with a monochromatic laser light. The irradiation power may be adjusted by the person of ordinary skill in the art in light of other factors such as foam-forming composition opacity, volumetric flow rate, and safety considerations. In certain embodiments as otherwise described herein, the irradiation is carried out at a power in the range of 0.1 W/cm² to 100 W/cm², or 1 W/cm² to 50 W/cm² (e.g., 2 W/cm² to 30 W/cm², or 4 W/cm² to 30 W/cm², or 4 W/cm² to 25 W/cm², or 4 W/cm² to 20 W/cm²).

In certain embodiments, the method further comprises allowing the irradiated foam-forming composition to finish curing adjacent the surface (e.g., within the cavity) to produce an insulating foam. Accordingly, another aspect of the present disclosure is an insulating foam formed as otherwise described herein, disposed adjacent a surface to be insulated (e.g., within a cavity such as building cavity. The insulating foam can be the polymerization reaction product of any of the foam-forming compositions as described herein.

The building cavity as otherwise described herein may be a space between two walls (e.g., between an exterior and interior wall). Alternatively, the building cavity may be integrated into a ceiling, roof, or floor. The insulating foam may substantially fill the cavity, or fill a portion of the cavity (e.g., resting against one wall or structural member, or filled from the bottom up as a result of gravity during dispensing). In other embodiments, the insulating foam may be installed as part of a building material. For example, the insulating foam may be formed on a wallboard or roofing member prior to installation. In further embodiments, the cured insulated foam composition is used for an application selected from acoustical insulation, air sealing, gasketing, cushioning, bedding, packaging, or as a floatation aid. But the present inventors contemplate that the methods, compositions and systems described herein can be used to insulate a wide variety of surfaces.

Another aspect of the present disclosure provides for a dispenser suitable for use in the methods described herein. The dispenser comprises:
one or more inlets in fluid communication with one or more sources of the foam-forming composition;
a fluid path in communication with the inlet(s),
an actuator configured to actuate flow of the foam-forming composition through the fluid path;
a light source irradiating the fluid path; and
an outlet in fluid communication with the fluid path,
   the device being configured to allow flow of foam-forming composition from the inlet(s), through the fluid path and out the outlet.

The dispenser can advantageously be configured to provide irradiation of the foam-forming composition immediately before injection adjacent a surface (e.g., into a cavity such as a wall cavity. Further, the dispenser can be provided as an integrated unit in which the irradiation light source, and fluid path with an outlet for dispensing are all contained within a single device. A source of the foam-forming composition can optionally be integrated with the dispenser, or in more typical configurations can be located at a distance connected to the dispenser by a tube or hose.

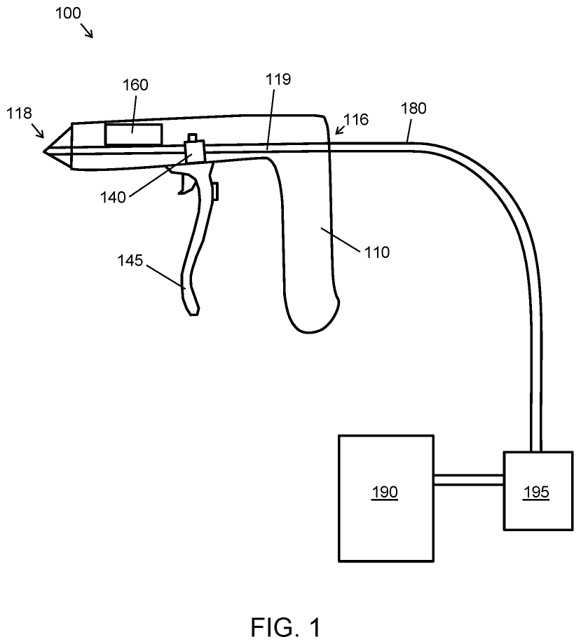

One embodiment of an insulation dispenser is shown in schematic cross-sectional view in FIG. 1. The insulation dispenser 100 includes a body 110, having one or more inlets 116 and an outlet 118, with a fluid path 119 extending therebetween. Only one inlet is shown in the embodiment of FIG. 1; such an embodiment is especially useful in cases where the foam-forming composition is provided to the dispenser with all components present, e.g., including the blowing agent. The person of ordinary skill in the art will appreciate based on the present disclosure that when a foam-forming precursor composition is to be combined with a blowing agent within the dispenser, a separate inlet can be provided for each, with the dispenser being configured to combine the components to provide the foam-forming composition. The one or more inlets can be coupled to a supply line 180, which can be coupled to one or more sources of the foam-forming composition 190. The dispenser also includes an actuator configured to actuate flow of the foam-forming composition through the fluid path. In the dispenser of FIG. 1, the actuator is a valve 140 that is user-actuable by a trigger 145; of course, other configurations are possible, including an electronically-controlled valve. The valve is configured to control fluid communication between the one or more inlets and the outlet such that fluid communication is allowed when the valve is open and fluid communication is allowed when the valve is closed. Critically, a light source 160 is configured to irradiate the fluid path. The light source can be, for example, configured to be actuated by the actuation of the flow, or can be turned on previously so that it stably provides irradiation throughout a number of dispensing steps.

The one or more inlets are provided in fluid communication with one or more sources of the foam-forming composition as described above. The one or more sources can be, e.g., one or more containers such as tanks, drums, buckets, etc. that provide the material to be polymerized and the blowing agent. A single container can be subdivided into individual compartments, and optionally may be comprised of distinct compartments separated in space from one another. In certain embodiments as otherwise described herein, the container comprises a compartment for a foam-forming precursor composition as otherwise described herein, and a second compartment for a blowing agent. As noted above, when the blowing agent and the foam-forming precursor composition are provided separately, the method can further comprise admixing the foam-forming precursor composition and the blowing agent prior to the irradiation, e.g., within the dispenser itself. One or more pumps (195 in FIG. 1) can be used, e.g., integrated with the dispenser and/or the source, in order to move material from the source to the dispenser. As the person of ordinary skill in the art will appreciate, a pump controller can be provided, e.g., on the dispenser itself or otherwise, to provide for control of the pump. In other embodiments, the sources are pressurized and material moves without pumps.

A variety of light sources can be used, e.g., lamps, lasers or light-emitting diodes provided as part of the dispenser as described above with respect to FIG. 1. Of course, in other embodiments, the light source can be one or more optical lightguides conducting radiation from an external source, e.g., an external lamp, light-emitting diode or laser. The person of ordinary skill in the art will select an appropriate lightguide.

Notably, the fluid path may also be designed to encourage turbulent flow of the foam-forming composition in the irradiation zone of the dispenser, thus increasing the effectiveness of the irradiation and allowing for more even curing. This can be the case even when the foam-forming composition is provided to the dispenser already mixed; turbulent flow of the material allows for all material to be conveyed to within the penetration depth of the irradiation, and thus be efficiently irradiated. Accordingly, in certain embodiments as otherwise described herein, the fluid path comprises a static mixer, e.g., formed as one or more protuberances in the fluid path, configured to provide turbulent flow within the irradiation zone. In other embodiments, the fluid path comprises a rotating mixer configured to provide turbulent flow within the irradiation zone.

In certain embodiments as otherwise described herein, the foam-forming composition is irradiated and injected using a dispenser. The dispenser itself may be of a variety of designs, for example designs know in the art as tube constructions, pneumatic spray guns, dispensing guns, foam applicator guns, atomizing nozzles, foam guns, foam dispensing guns, spray foam application guns, spray foam dispensing guns, foam dispensing tubes, and/or static mixer discharge tubes.

In certain embodiments, the user of the dispenser triggers the actuator to allow foam-forming composition to flow through the fluid path. The user may also trigger a pump which initiates flow of the foam-forming composition through the fluid path. The foam-forming composition is subject to irradiation from the light source, after which the irradiated foam-forming composition exits the dispenser through the outlet (e.g., through a nozzle) and enters the building cavity. Parameters such as volumetric flow rate of the foam-forming composition and power of the light source may be adjusted by the person of ordinary skill in the art in light of the present disclosure to allow effective irradiation and curing of the foam-forming composition.

In certain embodiments, the blowing agent and foam-forming composition are admixed immediately prior to irradiation. In particular embodiments, the flow rate of the foam-forming composition and the flow rate of the blowing agent are independent of one another. For example, in particular embodiments, the user may adjust the flow rate of the foam-forming composition, and/or the flow rate of the blowing agent, to adjust the admixture of the two and the resulting foam density. In certain embodiments as otherwise described herein, the intensity of the irradiation source may be adjusted by the user in order to provide optimum irradiation.

After the user begins dispensing the irradiated foam-forming composition, dispensing can continue until a desired time and/or volume of material is dispensed. In many embodiments, it may be preferable for the user to stop the dispensing through actuation of the actuator. This allows the user to provide control of the dispensing of the foam insulation in order to control the filling of the building cavity as desired.

In certain embodiments as otherwise described herein, the fluid path, or a portion of the fluid path, is interchangeable and/or disposable. For example, a first fluid path, or a first portion of the fluid path, may be designed to be detached from the dispenser after dispensing an amount of the irradiated foam-forming composition. Subsequently, in certain embodiments, a second fluid path, or a second portion of the fluid path, may be installed in the dispenser, and an additional portion of irradiated foam-forming composition may be dispensed by the user.

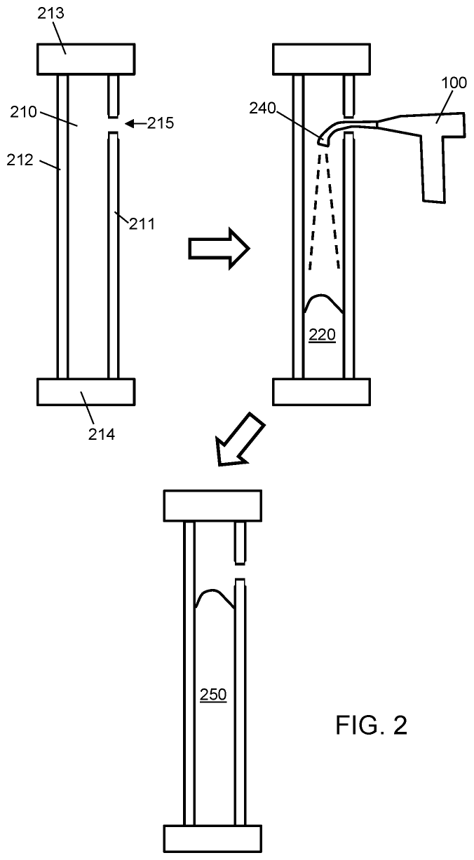

FIG. 2 is a schematic cross-sectional view of the dispensing of foam insulation into a building cavity, in this example, at least partially enclosed by one or more walls. Wall cavity 210 includes a first wall 211, a second wall 212, a third wall 213 and a fourth wall 214, defining a substantially enclosed cavity. Wall cavity 210 can be closed off by two additional walls, e.g., parallel to the plane of the page. As is conventional, these walls can be formed of a variety of materials, e.g., wallboard, lath and plaster, cement, wood, metal, and different materials can be used in different walls of a particular cavity. One or more of the walls enclosing the cavity can be formed from framing members; in the example of FIG. 2, the first and second walls are wallboards and the third and fourth walls are framing members. And the person of ordinary skill in the art can appreciate that different cavities may have different shapes and thus different numbers of walls enclosing them. As used herein, a “substantially enclosed” cavity is enclosed over at least 90%, e.g., at least 95% of its surface area. The cavity can be, for example, a wall cavity, a ceiling cavity, or a floor cavity. The cavity thus need not be entirely enclosed. The person of ordinary skill in the art will appreciate that the methods described herein can be used in the insulation of a wide variety of building cavities. Such cavities can, in some cases, already have fibrous insulation (e.g., fiberglass) disposed therein. Insulating foam insulation 220 (e.g., in a mixed and partially-expanded stated) is dispensed through an aperture 215 in the first wall 121 into the cavity 210 from an insulation dispenser 100 (often in the form of a “gun”), either directly from the tip of the dispenser or through a tube 240 extending into the cavity. After a volume of partially-expanded foam 220 is dispensed, it continues to expand to provide fully-expanded foam insulation 250 disposed in the cavity. Often, multiple “shots” of foam insulation are used to fill the cavity. After the desired amount of material is dispensed and expanded, the aperture can be patched if desired. A number of methods for dispensing foam insulation into building cavities are described in U.S. Patent Application Publications nos. 2017/0080614 and 2020/0149297, each of which is hereby incorporated herein by reference in its entirety. The person of ordinary skill in the art can adapt any of the methods described therein, as well as other methods for dispensing insulating foam, with the metering methods, devices and systems described here.

In another aspect, the present disclosure provides for a method of insulating a surface, the method comprising:
providing a dispenser as otherwise described herein; and
using the dispenser to irradiate a foam-forming composition and inject the foam-forming composition as otherwise described herein adjacent the surface as otherwise described herein.
   The surface can be, e.g., a surface of a cavity, such as a wall cavity. Thus, the injection can be an injection into the cavity.

Additional aspects of the disclosure are provided by the following enumerated claims, which can be combined and permuted in any number and in any combination that is not technically or logically inconsistent.

### EXAMPLES

### Materials

DETX (2,4-Diethyl-9H-thioxanthen-9-one) (Sigma Aldrich) was selected as photosensitizer and Irgacure 290 sulfonium cationic photoinitiator (substituted triarylsulfonium tetrakis(pentafluoromethyl)borate) (BASF) was selected a photoinitiator. Epoxy monomers used were Huntsman CY 179, a cycloaliphatic di-epoxy (7-oxabicyclo[4.1.0]heptan-3-yl)methyl 7-oxabicyclo[4.1.0]heptane-3-carboxylate), and Olin DER 332, a bisphenol A diepoxy. The photosensitizer and photoinitiator were dissolved in dipropylene glycol dimethyl ether (DMM) (Sigma Aldrich) and then added to the epoxy mixture. In foaming experiments, the surfactant employed was Siltech 2760 (a block copolymer of dimethylsiloxane and a polyoxyalkylene). Where desired, the flame retardants Saytex® RB 9170 (an aromatic bromine containing diol) (Albemarle) and Fyroflex® RDP (a diphenyl phosphate oligomer) (ICL Industrial Products) were used.

An air-cooled FJ100 150×20AC 395 nm 12W light source (Phoseon) was utilized, with a maximum intensity of 12 W/cm² and adjustable power. A syringe pump was used to inject the reactant mixture into the cylindrical exposure chamber at a constant rate. The syringe pump maximum flow rate was 35 mL/min, corresponding to a linear flow rate of approximately 2 cm/s of the epoxy flowing through the tube. The diode array was 15 cm×2 cm. Aluminum foil was wrapped around the UV source and exposure chamber to limit UV leakage and promote UV reflection back into the tube. The exposure chamber was made of fluorinated ethylene propylene polymer (FEP) tubing with a static mixer inserted within the tube. The exposure chamber was 15 cm long, matching the length of the diode array and had a 6.2 mm (¼ inch) diameter with 3.2 mm (⅛ inch) wall thickness. The UV transmission at 395 nm through this tubing was estimated to be 56% based on UV/Vis transmission measurements on pressed FEP films.

The Reynolds number for the epoxy mixtures was estimated in order to determine the flow regime of the reactants while passing through the exposure tube. The Reynolds number is given by the formula: Re=ρLν/η, wherein ρ is the density of the fluid, L is a characteristic dimension of the movement (e.g., diameter of a tube), ν is the speed of the liquid, and η is the viscosity of the solution.

For example, with the highest flow rate and the use of low-viscosity CY 179 (η˜350 mPa·s, and the ¼″ tube (6.3 mm diameter) it is possible to get a Reynolds of approximately Re=10⁻⁴, indicating laminar flow. The speed of the solution is zero on the edges of the tube where the UV light intensity and photopolymerization reaction are greatest. This situation would suggest that an undesirable thin film of cured epoxy would likely form and subsequently limit UV penetration and photosensitizer activation deeper in the tube.

Conventional formulations use a photosensitizer concentration of 1-2% photosensitizer for typical coating applications. Therefore, an extinction coefficient α of 4800 L·mol⁻¹ mm⁻¹ implies a penetration depth of approximately 0.03 mm. This suggests a short penetration depth where the laminar flow velocity of the mixture is extremely low. One should anticipate that it will be difficult to activate photosensitizer and photoinitiator through the entire tube cross-section unless the photosensitizer absorption is decreased by ˜50 times, for example by decreasing concentration by the same amount, utilizing a different photosensitizer, or introducing turbulent flow is introduced into the exposure chamber.

### Example 1: Screening Experiments of Reaction Conditions

Screening experiments were performed to identify the approximate ratio of catalyst, sensitizer and irradiation power that would yield catalyst activation and curing in a reasonable time. FIG. 1 depicts the approximate cure time of activated cycloaliphatic mixtures (in seconds) as a function of catalyst loading and light intensity. Here, the photosensitizer loading was fixed at 0.25% in an attempt to balance low penetration depth and sufficiently high catalyst activation. The curing time was either very long (more than 1 h) or so short that the polymer burned before exiting the FEP tube. The most promising recipe when the curing (and burning reaction) occurred just after material exited the tube had 2% of Irgacure 290 photoinitiator and 50% light intensity. Despite our calculation that most photoinitiator activation would occur close to the zero-velocity tube wall and probably form a UV-blocking skin layer, there is a significant amount of activated material that passes through the exposure tube to be collected and which subsequently polymerizes. However, activation within this extrudate is non-uniform, as evidenced by the sporadic appearance of red spots (activated photoinitiator) in the collected solution. Nonetheless, the experiment demonstrates that it is possible to extrude an activated, polymerizing mixture.

### Example 2: Foam-Forming Reactions

The impact of blowing agent and foam-forming composition on the curing process using the static mixer was explored. Three formulations were prepared, with the components as shown in Table 1. Formulations 1 and 2 tested the impact of introducing blowing agent and bisphenol A epoxy on the foam reaction, and Formulation 3 includes a mixture of two flame retardants. In all cases, the molar ratio of Enovate blowing agent to epoxy is 0.3609 and the mass ratio of Silstab surfactant to epoxy is 5.41.

TABLE 1
Foam-forming compositions

| | Formulation 1 | | Formulation 2 | | Formulation 3 | |
|---|---|---|---|---|---|---|
| Component | in grams (wt %) | | in grams (wt %) | | in grams (wt %) | |
| CY 179 | 30 | (62.1) | 15 | (35.14) | 1.6 | (3.60) |
| DER 332 | — | | 15 | (35.14) | 26.2 | (58.95) |
| Irgacure 290 | 0.615 | (1.27) | 0.6165 | (1.44) | 0.605 | (1.36) |
| DETX | 0.0885 | (0.18) | 0.0885 | (0.21) | 0.0810 | (0.18) |
| DMM | 3.306 | (6.84) | 3.2925 | (7.71) | — | |
| Silstab | 1.10 | (2.28) | 0.89 | (2.08) | 0.86 | (0.18) |
| Enovate | 13.2 | (27.32) | 7.8 | (18.27) | 7 | (15.75) |

| | | | | |
|---|---|---|---|---|
| RB 9170 | — | — | 5.55 | (12.49) |
| Fyroflex RDP | — | — | 2.55 | (5.74) |

CY 179 is a cycloaliphatic epoxy; DER 332 is a BPA di-epoxy; Irgacure 290 is a sulfonium photoinitiator; DETX is photosensitizer with formula 2,4-diethyl-9H-thioxanthen-9-one; DMM is a solvent with formula dipropylene glycol dimethyl ether; Silstab 2760 is a block copolymer of dimethylsiloxane and a polyoxyalkylene; Enovate is a blowing agent with formula 1,1,1,3,3-pentafluoropropane; RB 9170 is a proprietary aromatic bromine containing diol; and Fyroflex® RDP is a diphenyl phosphate oligomer.

Formulations 1 and 2 were tested first without blowing agent to identify the UV intensity at which the resin can cure. Formulation 1 showed facile activation (as evidenced by a color change in the photoinitiator and observed polymerization) at 45% light intensity, as was found in the screening experiment. Formulation 2 shows an incomplete activation (i.e. appearance of orange dots indicative of energy transfer and activation of the photoinitiator) even after the light intensity was increased to 75%. Surprisingly, it was still anticipated that the catalyst activation itself would be independent of epoxy presence. Separately, we confirmed that DER 332 does not absorb in wavelength higher than 300 nm, and thus its presence would not block UV absorption by the photosensitizer.

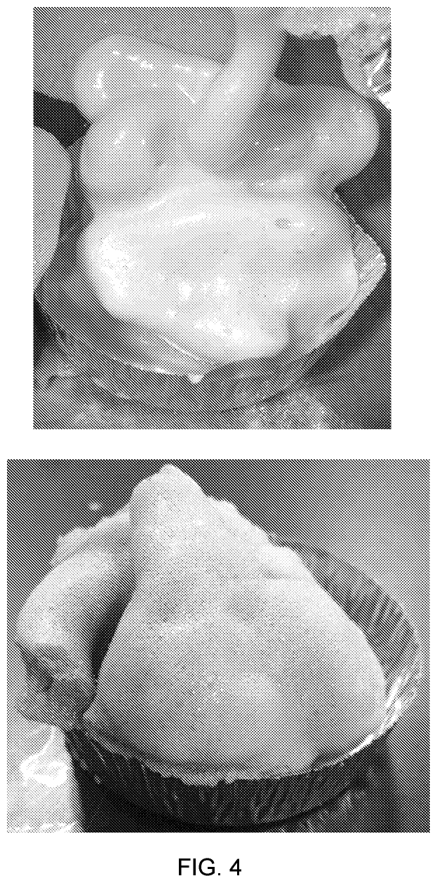

With the addition of blowing agent and surfactant to the epoxy mixture, blowing agent evaporation was observed within the static mixer tube during light illumination. Surprisingly, minimal additional energy was found to be necessary to initiate polymerization despite the effective dilution of ingredients with the incorporation of a blowing agent, as the blowing agent appears to fortuitously enhance the mixing of the reactants. FIG. 4 shows samples taken from Formulation 1 at the beginning (top) and end (bottom) of a trial, with a 45% irradiation intensity (5.4 W/cm²), where the trial consisted of pumping the Formulation past the irradiation chamber. The mixture had a frothed appearance as it exited the tube and immediately began to rise. All samples cured rapidly and were only slightly tacky after only one minute.

Formulation 2, being a 50/50 mixture of cycloaliphatic epoxy and bisphenol A epoxy, was more difficult to activate. When irradiated at an intensity of 75% (9 W/cm²), the formulation began to cure immediately after being extruded. With the addition of a blowing agent, it was required to increase the irradiation intensity to 85% (10.2 W/cm²) to achieve adequate curing. Qualitatively, the Formulation 2 foams appeared to have more open cells as compared to Formulation 1.

Formulation 3 was very foamy and white in color, and failed to cure even at high intensity (100%). Likely, this is due to the strong scattering of the white foam that decreased the amount of energy reaching the reactants, potentially caused by lower solubility of the blowing agent within the DER332 epoxy, leading to phase separation.

Additional aspects and embodiments of the disclosure are provided by the following enumerated embodiments, which may be combined in any number and in any combination that is not technically or logically inconsistent.
Embodiment 1. A method of insulating a surface (e.g., a cavity such as a building cavity) with an insulating foam, the method comprising:
   irradiating a foam-forming composition with light, the foam-forming composition comprising:
      a polymerizable component (e.g., based on epoxy or acrylate) (e.g., present in the range of 20 wt % to 90 wt %);
      an effective amount of a photoinitiator (e.g., present in in the range of 0.1 wt % to 4 wt %); and
      a blowing agent (e.g., in the range of 10 wt % to 40 wt %); and
   injecting the irradiated foam-forming composition adjacent the surface (e.g., into a cavity).
Embodiment 2. The method of embodiment 1, wherein the polymerizable component is a polymerizable epoxy component.
Embodiment 3. The method of embodiment 2, wherein the polymerizable epoxy component comprises a cycloaliphatic epoxy (e.g., a cycloaliphatic di-epoxy).
Embodiment 4. The method of embodiment 3, wherein the cycloaliphatic epoxy component comprises an epoxy with the structure:

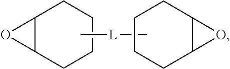

wherein:
L is a bridging C₂-C₁₂ alkyl group, C₂-C₁₂ alkenyl group, or —(C₀-C₆ alkyl)-X-(C₀-C₆ alkyl)-, wherein X is —O—, —C(O)—O—, —O—C(O)—O—, —O—C(O)—N(R^{A})—, —N(R^{A})—C(O)—, —N(R^{A})—C(O)—N(R^{B})—, or —N(R^{A})—, wherein R^{A} and R^{B} are independently H, methyl, or ethyl; and
L is optionally substituted by 1-4 groups selected from C₁-C₄ alkyl, halo, oxo, and —OH.
Embodiment 5. The method of embodiment 4, wherein L is —(C₀-C₃ alkyl)-X-(C₀-C₃ alkyl)-.
Embodiment 6. The method of embodiment 4 or embodiment 4, wherein X is —C(O)—O—.
Embodiment 7. The method of embodiment 2, wherein the polymerizable epoxy component comprises bis-phenol A di-epoxy, cyclohexene oxide, 4-vinyl-1,2-cyclohexene oxide, limonene dioxide, 4-epoxy-1,2-cyclohexene oxide, dicyclopentadiene diepoxide, neopentyl glycol diglydicyl ether, 1,4-butanediol diglycidyl ether, or benzyl glycidyl ether, or a combination thereof.
Embodiment 8. The method of any of embodiments 2-7, wherein the photoinitiator comprises at least one of a sulfonium salt, iodonium salt, or ferrocenium salt (e.g., salt of hexafluorophosphate, tetrafluoroborate, or hexafluoroarsenate).
Embodiment 9. The method of embodiment 8, wherein the photoinitiator comprises a sulfonium salt.
Embodiment 10. The method of embodiment 1, wherein the polymerizable component is a polymerizable acrylate-based component.
Embodiment 11. The method of embodiment 10, wherein the polymerizable component includes one or more acrylate- or methacrylate-terminated oligomers.
Embodiment 12. The method of embodiment 10 or embodiment 11, wherein the polymerizable component includes one or more mono- or multifunctional (meth)acrylate monomers.
Embodiment 13. The method of any of embodiments 10-13, wherein the photoinitiator is a free radical photoinitiator.
Embodiment 14. The method of any of embodiments 1-13, wherein the polymerizable component is present in the foam-forming composition in the range of 30 wt % to 90 wt %, or 40 wt % to 90 wt %, or 50 wt % to 90 wt %, or 60 wt % to 90 wt %, or 20 wt % to 80 wt %, or 30 wt % to 80 wt %, or 40 wt % to 80 wt %, or 50 wt % 80 wt %, or 20 wt % to 70 wt %, or 30 wt % to 70 wt %, or 40 wt % to 70 wt %. [symbol] 11.
Embodiment 15. The method of any of embodiments 1-14, wherein the photoinitiator is present in an amount in the range of 0.1 wt % to 4 wt %, e.g., 0.2 wt % to 3 wt %, or 0.5 wt % to 3 wt %, or 0.75 wt % to 3 wt %, or 1 wt % to 3 wt %.
Embodiment 16. The method of any of embodiments 1-15, wherein the composition further comprises a photosensitizer in the range of 0.01 wt % to 1 wt %.
Embodiment 17. The method of embodiment 16, wherein the photosensitizer comprises a polycyclic aromatic compound (e.g., a tricyclic compound, such as at least one of anthracene and 2,4-diethyl-9H-thioxanthene-9-one).
Embodiment 18. The method of any of embodiments 1-17, wherein the blowing agent is a fluorocarbon.
Embodiment 19. The method of any of embodiments 1-18, further comprising a solvent, e.g., in the range of 2 wt % to 30 wt %.
Embodiment 20. The method of embodiment 19, wherein the solvent comprises a polyol or polyether, such as a propylene glycol derivative (e.g., dipropylene glycol dimethyl ether).
Embodiment 21. The method of any of embodiments 1-20, wherein the foam-forming composition further comprises a flame retardant, e.g., in the range of 1 wt % to 30 wt %.
Embodiment 22. The method of any of embodiments 1-21, wherein the foam-forming composition is substantially free of isocyanates, polyolefins, and butadienes.
Embodiment 23. The method of any of embodiments 1-22, further comprising adding the blowing agent to a foam-forming precursor composition to produce the foam-forming composition immediately prior to irradiation, wherein the foam-forming precursor composition comprises the polymerizable component (e.g., in the range of 20 wt % to 80 wt %) and the photoinitiator (e.g., in the range of 0.1 wt % to 4 wt %.)
Embodiment 24. The method of any of embodiments 1-23, wherein the injecting is performed immediately subsequent to the irradiation of the foam-forming composition.
Embodiment 25. The method of any of embodiments 1-24, wherein, after injecting the irradiated foam-forming composition adjacent the surface (e.g., into a cavity such as a building cavity), the foam-forming composition is exposed to substantially no further irradiation.
Embodiment 26. The method of any of embodiments 1-25, further comprising: allowing the irradiated foam-forming composition to finish curing within the building cavity to produce a cured foam composition.
Embodiment 27. The method of any of embodiments 1-26, wherein the irradiating is performed with light having a wavelength in the range of 200 nm to 600 nm.
Embodiment 28. The method of any of embodiments 1-27, wherein the irradiating and the injecting is performed using a dispenser.
Embodiment 29. The method of embodiment 28, wherein the dispenser comprises:
   one or more inlets in fluid communication with one or more sources of the foam-forming composition;
   a fluid path in communication with the inlet,
   an actuator configured to actuate flow of the foam-forming composition through the fluid path;
   a light source configured to irradiate the fluid path; and
   an outlet in fluid communication with the fluid path,
      the device being configured to allow flow of foam-forming composition from the inlet, through the fluid path and out the outlet.
Embodiment 30. The method of embodiment 29, further comprising, after injecting the irradiated foam-forming composition into the building cavity:
   removing a first portion of the fluid path;
   installing a second portion of the fluid path in the place of the first portion.
Embodiment 31. An insulating foam, formed through the method of any of embodiments 1-30.
Embodiment 32. A dispenser for injecting a foam-forming composition into a building cavity, the dispenser comprising:
   one or more inlets in fluid communication with one or more sources of the foam-forming composition as described in any of embodiments 1-27;
   a fluid path in communication with the inlet(s),
   an actuator configured to actuate flow of the foam-forming composition through the fluid path;
   a light source configured to irradiate the fluid path; and
   an outlet in fluid communication with the fluid path,
      the device being configured to allow flow of foam-forming composition from the inlet(s), through the fluid path and out the outlet.
Embodiment 33. The dispenser according to embodiment 32, wherein the fluid path comprises a mixer (e.g., a static mixer).
Embodiment 34. The dispenser according to embodiment 32 or embodiment 33, wherein the light source comprises one or more light-emitting diodes.
Embodiment 35. A method of insulating a surface, the method comprising:
   providing a dispenser (e.g., the dispenser according to any of embodiments 32-34); and
   using the dispenser to irradiate a foam-forming composition and inject the foam-forming composition adjacent the surface (e.g., the foam-forming composition as described in any of embodiments 1-30).
Embodiment 36. The method of embodiment 35, wherein the surface is a surface of a cavity (e.g., a building cavity) and the injection is an injection into the cavity.

It will be apparent to those skilled in the art that various modifications and variations can be made to the processes and devices described here without departing from the scope of the disclosure. Thus, it is intended that the present disclosure cover such modifications and variations of this invention provided they come within the scope of the appended claims and their equivalents.

What is claimed is:

1. A method of insulating a surface (e.g., a cavity such as a building cavity) with an insulating foam, the method comprising:
irradiating a foam-forming composition with light, the foam-forming composition comprising:
a polymerizable component (e.g., based on epoxy or acrylate) (e.g., present in the range of 20 wt % to 90 wt %);
an effective amount of a photoinitiator (e.g., present in in the range of 0.1 wt % to 4 wt %); and
a blowing agent (e.g., in the range of 10 wt % to 40 wt %); and
injecting the irradiated foam-forming composition adjacent the surface (e.g., into a cavity).

2. The method of claim 1, wherein the polymerizable component is a polymerizable epoxy component.

3. The method of claim 2, wherein the polymerizable epoxy component comprises an epoxy with the structure: 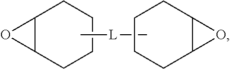
wherein:
L is a bridging C₂-C₁₂ alkyl group, C₂-C₁₂ alkenyl group, or —(C₀-C₆ alkyl)-X-(C₀-C₆ alkyl)-, wherein X is —O—, —C(O)—O—, —O—C(O)—O—, —O—C(O)—N(R^{A})—, —N(R^{A})—C(O)—, —N(R^{A})—C(O)—N(R^{B})—, or —N(R^{A})—, wherein R^{A} and R^{B} are independently H, methyl, or ethyl; and
L is optionally substituted by 1-4 groups selected from C₁-C₄ alkyl, halo, oxo, and —OH.

4. The method of claim 3, wherein the polymerizable epoxy component comprises bis-phenol A di-epoxy, cyclohexene oxide, 4-vinyl-1,2-cyclohexene oxide, limonene dioxide, 4-epoxy-1,2-cyclohexene oxide, dicyclopentadiene diepoxide, neopentyl glycol diglydicyl ether, 1,4-butanediol diglycidyl ether, or benzyl glycidyl ether, or a combination thereof.

5. The method of claim 2, wherein the photoinitiator comprises at least one of a sulfonium salt, iodonium salt, or ferrocenium salt (e.g., salt of hexafluorophosphate, tetrafluoroborate, or hexafluoroarsenate).

6. The method of claim 1, wherein the polymerizable component is a polymerizable acrylate-based component.

7. The method of claim 6, wherein the polymerizable component includes one or more mono- or multifunctional (meth)acrylate monomers.

8. The method of claim 6, wherein the photoinitiator is a free radical photoinitiator.

9. The method of claim 1, wherein the composition further comprises a photosensitizer in the range of 0.01 wt % to 1 wt %.

10. The method of claim 1, wherein the blowing agent is a fluorocarbon.

11. The method of claim 1, wherein the foam-forming composition further comprises a flame retardant, e.g., in the range of 1 wt % to 30 wt %.

12. The method of claim 1, wherein the foam-forming composition is substantially free of isocyanates, polyolefins, and butadienes.

13. The method of claim 1, further comprising adding the blowing agent to a foam-forming precursor composition to produce the foam-forming composition immediately prior to irradiation, wherein the foam-forming precursor composition comprises the polymerizable component (e.g., in the range of 20 wt % to 80 wt %) and the photoinitiator (e.g., in the range of 0.1 wt % to 4 wt %.)

14. The method of claim 1, wherein the injecting is performed immediately subsequent to the irradiation of the foam-forming composition.

15. The method of claim 1, wherein, after injecting the irradiated foam-forming composition adjacent the surface (e.g., into a cavity such as a building cavity), the foam-forming composition is exposed to substantially no further irradiation.

16. The method of claim 1, further comprising: allowing the irradiated foam-forming composition to finish curing within the building cavity to produce a cured foam composition.

17. The method of claim 1, wherein the irradiating and the injecting is performed using a dispenser comprising:
one or more inlets in fluid communication with one or more sources of the foam-forming composition;
a fluid path in communication with the inlet,
an actuator configured to actuate flow of the foam-forming composition through the fluid path;
a light source configured to irradiate the fluid path; and
an outlet in fluid communication with the fluid path,
the device being configured to allow flow of foam-forming composition from the inlet, through the fluid path and out the outlet.

18. The method of claim 17, further comprising, after injecting the irradiated foam-forming composition into the building cavity:
removing a first portion of the fluid path;
installing a second portion of the fluid path in the place of the first portion.

19. An insulating foam, formed through the method of claim 1.

20. A dispenser for injecting a foam-forming composition into a building cavity, the dispenser comprising:
one or more inlets in fluid communication with one or more sources of the foam-forming composition as described in claim 1;
a fluid path in communication with the inlet(s),
an actuator configured to actuate flow of the foam-forming composition through the fluid path;
a light source configured to irradiate the fluid path; and
an outlet in fluid communication with the fluid path,
the device being configured to allow flow of foam-forming composition from the inlet(s), through the fluid path and out the outlet.

21. A method of insulating a surface, the method comprising:
providing a dispenser according to claim 20; and
using the dispenser to irradiate a foam-forming composition as described in claim 1 and inject the foam-forming composition adjacent the surface.

22. The method of claim 21, wherein the surface is a surface of a cavity (e.g., a building cavity) and the injection is an injection into the cavity.
